(19) United States
(12) Patent Application Publication
(10) Pub. No.: US 2007/0230290 A1
(43) Pub. Date: Oct. 4, 2007

(54) Random play system and method

(75) Inventor: Chaucer Chiu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,546

(22) Filed: Mar. 30, 2006

(51) Int. Cl. G11B 21/08; G06F 12/00; G11B 7/085; G06F 13/28; G06F 13/00

(52) U.S. Cl. 369/30.08; 711/156

(57) ABSTRACT

A random play system for processing a playlist having a plurality of play series numbers and media files to be played so as for the random play system to determine play states of the media files. The random play system includes a first register for storing a number of the media files; a second register having a plurality of bits respectively corresponding to the media files, the bits respectively marking current play states of the media files; a selecting module for randomly selecting one of media files while performing a play task; an analyzing module for analyzing a play state of the selected media file according to a value represented by the bits; and a playing module for playing the selected media file when the analyzing module analyzed that the play state of the selected media file indicates that the selected media file has not been played yet.

### BACKGROUND OF THE INVENTION

1. Field of the Invention

The present invention relates to a random play system and method, and more particularly to a random play system and method by which media files can be played without repeat.

2. Description of Related Art

With rapid development of the electronic technology, media play devices for entertainment purposes have become one of the necessary parts in people's daily life. Currently, most of the media play devices such as MP3 players are provided with a random play function, which is achieved by generating a random number through a specific program, finding a media file corresponding to the random number from a playlist, and then playing the media file. However, the above method can not ensure all the generated random numbers in a same cycle are different from each other. Therefore, during a random play, it may happen that some media files have been played several times while other media files have never been played. Accordingly, a user has to cancel the random play function in order to enjoy all the media files of a playlist. Thus, the application value of the random play function is adversely affected.

### SUMMARY OF THE INVENTION

In light of the above drawbacks in the conventional technology, an objective of the present invention is to provide a random play system and method for a media play device, by which all the media files can be played in a same cycle without repeat.

Another objective of the present invention is to provide a random play system and method which can select a media file to be played by bit operation without affecting the play speed.

To achieve the above and other objectives, the present invention proposes a random play system and method. The random play system of the present invention is used for processing a playlist comprising a plurality of media files to be played so as to determine play states of the plurality of media files, wherein the playlist at least comprises play items and play series numbers corresponding to the play items. The random play system comprises: a first register for storing the number of the media files of the playlist; a second register comprising a plurality of bits respectively corresponding to the media files of the playlist, wherein the plurality of bits respectively marks the current play states of the media files of the playlist; a selecting module for randomly selecting a media file from the playlist while performing a play task; an analyzing module for analyzing the play state of the media file selected by the selecting module according to the information stored in the second register; and a playing module for playing the media file when the analyzing module identifies that the media file has not been played.

In the second register, a bit value equal to a predefined first value indicates that the media file corresponding to the bit has not been played, while a bit value equal to a predefined second value indicates that the media file corresponding to the bit has been played.

The selecting module further comprises a random number generator for generating a random number; and a converting unit for converting the random number generated by the random number generator into a play series number of the playlist according to a predefined operation mechanism.

The random play system further comprises a processing module and an adjusting module. The processing module comprises a marking unit for changing the value of a bit in the second register equal to the first value to the second value when a media file of the playlist corresponding to the bit is played; a counter for counting the number of the media files that have been played by the playing module; a comparing unit for comparing whether the number of the media files counted by the counter is bigger than the number of the media files stored in the first register; and an initializing unit for setting each of the bits of the second register to the first value when the comparing unit identifies that the number of media files counted by the counter is bigger than the number of the media files stored in the first register. The adjusting module is used for adjusting the play series number according to a predefined operation mechanism when the analyzing module identifies that the media file has been played, and sending the adjusted play series number to the analyzing module for analyzing.

The random play method of the present invention is applicable to a random play system for processing a playlist that comprises a plurality of media files to be played so as to determine play states of the plurality of media files, wherein the playlist at least comprises play items and play series numbers corresponding to the play items. The random play method comprises the steps of: storing the number of the media files of the playlist; marking the play states of the media files of the playlist and storing the marking information in a flag register; selecting a media file from the playlist while performing a play task; analyzing the play state of the media file selected by the selecting module according to the information stored in the flag register; and playing the media file when the analyzing result indicates that the media file has not been played.

The flag register comprises a plurality of bits respectively corresponding to the media files of the playlist, wherein the plurality of bits respectively marks the current play states of the media files of the playlist. A bit value equal to a predefined first value indicates that the media file corresponding to the bit has not been played, while a bit value equal to a predefined second value indicates that the media file corresponding to the bit has been played.

The random play method further comprises generating a random number by a random number generator; and converting the random number generated by the random number generator into a play series number of the playlist according to a predefined operation mechanism.

The random play method further comprises marking the play state of a media file in the flag register when the media file is played; counting the number of the media files that have been played; comparing whether the number of the media files that have been played is bigger than the number of the media files of the playlist; setting each of the bits in the flag register to the first value when the comparing result indicates that the number of the media files that have been played is bigger than the number of the media files of the playlist; and clearing the counter.

The random play method further comprises adjusting the play series number according to a predefined operation mechanism when the analyzing result indicates that the media file has been played and analyzing the play state of the media file corresponding to the adjusted play series number according to the information stored in the flag register.

The random play system and method of the present invention selects media files by bit operation. Thus, during a random play, all the play items can be played in a same cycle without repeat and without affecting the play speed.

### BRIEF DESCRIPTION OF DRAWINGS

FIG. 1 is a functional block diagram of a random play system of the present invention; and

FIG. 2 is a flow chart of a random play method of the present invention.

### DETAILED DESCRIPTION OF PREFERRED EMBODIMENTS

Hereunder, embodiments of the present invention will be described in full detail with reference to the accompanying drawings.

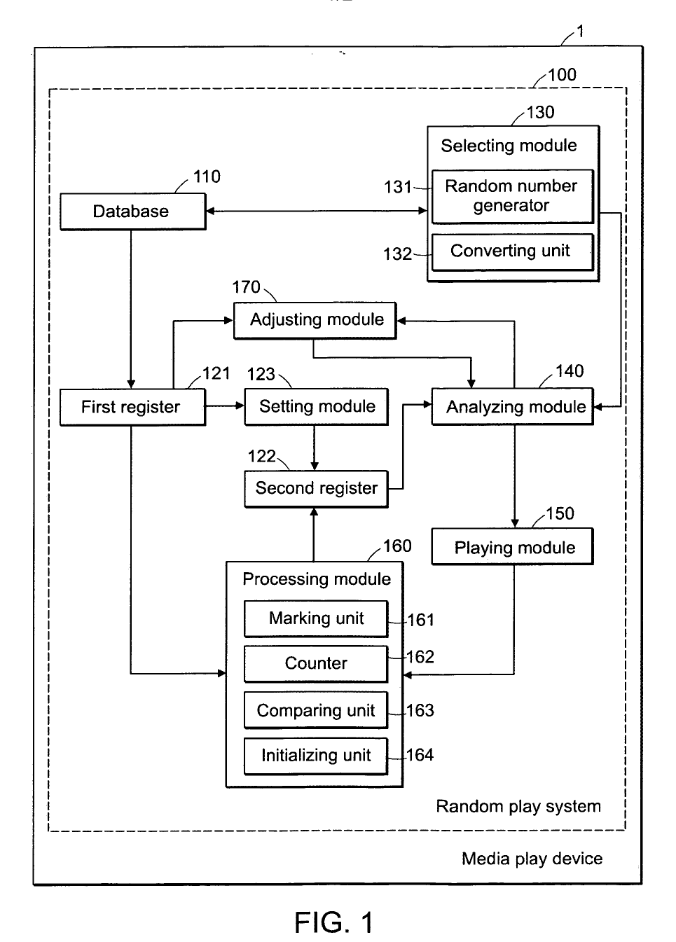

FIG. 1 is a functional block diagram of a random play system 100 according to the present invention. The random play system 100 of the present invention can be applied to a media play device 1, which can be a MP3 player or a media play program running in a personal computer such as windows media player or winamp. In the present embodiment, the random play system 100 comprises a database 110, a first register 121, a second register 122, a setting module 123, a selecting module 130, an analyzing module 140, a playing module 150, a processing module 160 and an adjusting module 170.

The database 110 is used for storing a playlist comprising a plurality of media files to be played by the media play device 1. In the present embodiment, the playlist (not shown) comprises fields of “play item”, “play series number”, “play length” and so on. The “play item” field contains the names of the media files to be played. The “play series number” field contains a plurality of play series numbers that are automatically generated sequence numbers, wherein each of the play series numbers corresponds to one of the media files of the playlist. The length of time to play a media file is specified in the “play length” field. The playlist is conventional in the art and not to be further detailed herein. In addition, the playlist can be stored in other memories besides the database.

The first register 121 is used for storing the number of the media files of the playlist. In general, the number of the media files stored in the first register 121 is equal to the maximum value in the “play series number” field of the playlist.

The second register 122 is a flag register comprising a plurality of bits, wherein each of the bits corresponds to a media file of the playlist and marks the play state of the media file. In the present embodiment, a bit value of “0” indicates the corresponding media file has not been played; while a bit value of “1” indicates the corresponding media file has been played. However, the marking method is not limited thereto. A first value and a second value can be set by users for identifying whether a media file has been played. For example, a bit value of “1” can be used to indicate the corresponding media file has not been played while a bit value of “0” can be used to indicate the corresponding media file has been played.

The setting module 123 is used for setting a data type for the second register 122 according to the number of the media files stored in the first register 121. Since each of the bits in the second register 122 corresponds to a play item of the playlist, the data type of the second register 122 to be set only needs to ensure the number of the bits in the second register 122 is not smaller than the number of the play items, thereby saving the storage space. For example, if the number of the media files stored in the first register 121 is not bigger than 16, a 16-bit short integer data type can be specified for the second register 122; if the number of the media files stored in the first register 121 is not bigger than 32, a 32-bit integer data type can be specified for the second register 122; if the number of the media files stored in the first register 121 is not bigger than 64, a 64-bit long integer data type can be specified for the second register 122, and so on.

The selecting module 130 is used for randomly selecting a media file while performing a play task. In the present embodiment, the selecting module 130 further comprises a random number generator 131 and a converting unit 132. The random number generator 131 generates a random number by referring to the current time such that the generated random numbers are different from each other, thereby reducing the probability of reselecting a same play item. The converting unit 132 converts the generated random number into a play series number of the playlist through a predefined operation mechanism, that is, the generated random number is limited into the scope of the play series numbers of the playlist through a modulo operation. For example, supposing the number of the play items of the playlist (denoted by t) is the scope of the play series numbers of the playlist 1-100, when the random number generator 131 generates a random number of 120, the converting unit 132 converts the random number by a modulo operation to obtain a play series number (denoted by c). That is, the play series number (c) is a remainder of division of the random number (s) by the number of the play items (t) (i.e. (c)=(s)%(t)), which is equal to 20 in the present example.

The analyzing module 140 reads a bit value from the second register 122 according to the play series number selected by the selecting module 130 and analyzes whether the media file corresponding to the selected play series number has been played according to the bit value.

The playing module 150 plays the above media file when the analyzing module 140 has identified that the media file has not been played.

The processing module 160 further comprises a marking unit 161, a counter 162, a comparing unit 163 and an initializing unit 164. The marking unit 161 changes the value of one of the bits stored in the second register 122 when the media file corresponding to the bit has been played. The counter 162 counts the number of the media files that have been played. Once the playing module 150 starts/ends playing a play item of the playlist, the counter 162 adds one to a count number so as to obtain a total number of the media files that have been played. The comparing unit 163 compares whether the count number of the media files counted by the counter 162 is bigger than the number of the media files stored in the first register 121. The initializing unit 164 sets each of the bit in the second register 122 to the first value (e.g.“0”) when the comparing unit 163 indicates that the number of the media files counted by the counter 162 is bigger than the number of the media files stored in the first register 121.

The adjusting module 170 is used for adjusting the play series number according to a predefined operation mechanism when the analyzing module 140 identifies that the media file has been played (described later), and sending the adjusted play series number to the analyzing module 140 for reanalyzing, thereby determining whether the corresponding play item has been played.

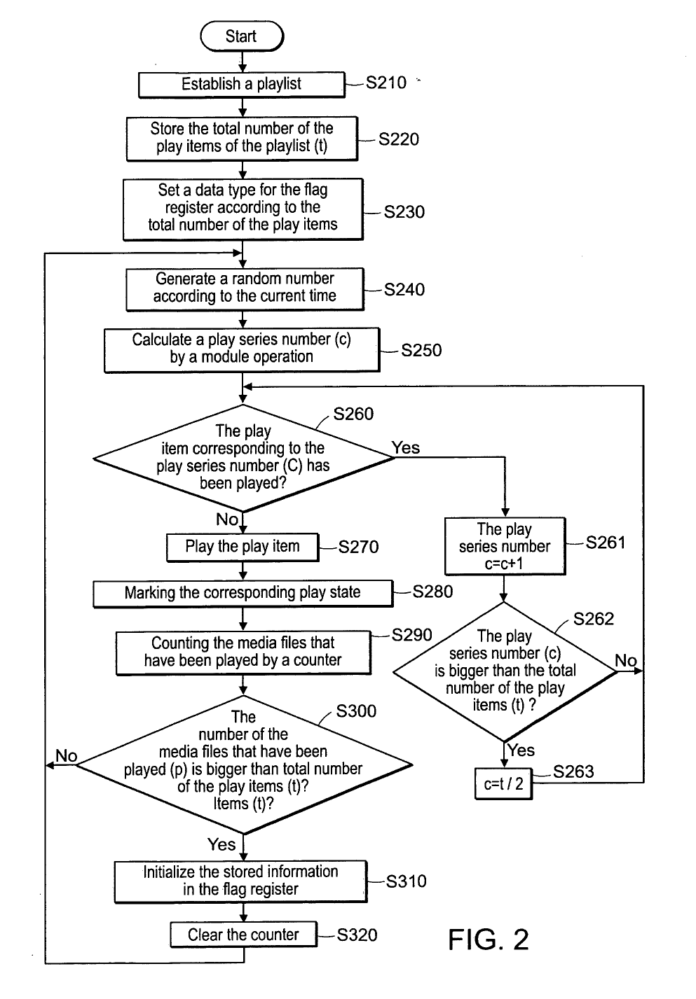

FIG. 2 shows the steps of a random play method of the present invention. The random play method of the present invention can be applied to a media play device 1 having a random play system 100. As shown in FIG. 2, first at step S210, a plurality of media files to be played is selected such that a playlist (not shown) corresponding to the plurality of media files can automatically be created. Each of the play items of the playlist corresponds to a media file and a play series number corresponding to the media file is automatically generated. In the present embodiment, the play series numbers are automatically arranged sequence numbers. The playlist comprises fields of “play series number”, “play item” and “play length” (play time). Then, routine proceeds to step S220.

At step S220, the total number of the play items of the playlist (t) is stored. Then proceed to step S230.

At step S230, the data type for the flag register indicating the current play states of the play items is set according to the total number (t) of the play items, and meanwhile each of the bits in the flag register is set to “0”. Then proceed to step S240.

At step S240, a random number (s) is generated by a random number generator 131. Then, routine proceeds to step S250.

At step S250, a play series number (c) corresponding to the random number (s) is calculated according to expression (c)=(s)%(t). Then, routine proceeds to step S260.

At step S260, the value of the bit corresponding to the play series number (c) is read from the second register 122 in order to identify the current play state of the play item corresponding to the play series number. If the value of the bit is equal to the first value (for example “0”), it indicates that the play item has not been played, and routine proceeds to step S270, otherwise, if the value of the bit is equal to the second value (for example “1”), it means that the play item has been played, and routine proceeds to step S261.

At step S261, another play series number is selected according to expression (c)=(c)+1. Then, routine proceeds to step S262.

At step S262, the play series number (c) is compared with the number of the play item (t). If the play series number (c) is bigger than the number of the play item (t), routine proceeds to step S263, otherwise, routine goes back to step S260.

At step S263, (c) is calculated according to expression (c)=(t)/2, then routine goes back to step S260.

At step S270, the selected play item is played. Then, routine goes to step S280.

At step S280, the value of the bit in the flag register corresponding to the play item is changed from “0” to “1”. Then, routine goes to step S290.

At step S290, the number of the media files (p) that have been played is counted by the counter 162. Then, go to step S300.

At step S300, (p) is compared with (t). If (p) is bigger than (t), it indicates that all the play items of the playlist have been played in the same cycle and routine proceeds to step S310, otherwise, routine goes back to step S240.

At step S310, the value of each of the bits indicating the current play state of the media files is changed from the second value (e.g. “1”) to the first value (e.g. “0”). Then proceed to step S320.

At step S320, the counter 162 is cleared and routine goes back to step S240 for another play cycle.

Therefore, the random play system and method of the present invention achieves the following effects:
(1) the present invention provides a random play function for a random play device, wherein all the media files of a playlist can be played in a same play cycle without repeat play;
(2) the present invention selects a media file to be played by bit operation without affecting the running speed of the program; and
(3) the present invention does not need any additional hardware and accordingly does not increase costs.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A random play system for processing a playlist comprising a plurality of media files to be played so as for the random play system to determine play states of the media files, wherein the playlist further comprises play items and play series numbers corresponding to the play items, the random play system comprising:
a first register for storing a number of the media files of the playlist;
a second register comprising a plurality of bits respectively corresponding to the media files of the playlist, wherein the plurality of bits respectively mark current play states of the media files of the playlist;
a selecting module for randomly selecting one of media files while performing a play task;
an analyzing module for analyzing a play state of the selected media file according to a value represented by the bits of the second register; and
a playing module for playing the selected media file when the analyzing module analyzed that the play state of the selected media file indicates that the selected media file has not been played yet.

2. The random play system of claim 1, wherein the second register is a flag register.

3. The random play system of claim 1, wherein that the value is equal to a predefined first value indicates that one of the media files corresponding to the bits has not been played yet, and that the value is equal to a predefined second value indicates that another one of the media files corresponding to the bits has already been played.

4. The random play system of claim 1, further comprising a setting module for setting a data type for the second register according to the number of the media files stored in the first register.

5. The random play system of claim 4, wherein the data type is one selected from a group consisting of a short integer, an integer and a long integer.

6. The random play system of claim 1, wherein the selecting module further comprising:
a random number generator for generating a random number; and
a converting unit for converting the random number generated by the random number generator into a play series number of the playlist according to a predefined operation mechanism.

7. The random play system of claim 6, wherein the random number generator generates a random number by referring to a current time.

8. The random play system of claim 6, wherein the converting unit limits the random number generated by the random number generator within the play series numbers of the playlist based on a modulo operation.

9. The random play system of claim 1, further comprising a processing module which comprises:
a marking unit for changing a value of the bits corresponding to one of the media files from a first value to a second value when the playing module is playing the media file;
a counter for counting a count number of the media files that have been played by the playing module;
a comparing unit for comparing the count number counted by the counter and the number of the media files stored in the first register; and
an initializing unit for setting each of the bits of the second register to the first value when the comparing unit compares that the count number counted by the counter is bigger than the number of the media files stored in the first register.

10. The random play system of claim 1, further comprising an adjusting module for adjusting the play series numbers according to a predefined operation mechanism when the analyzing module analyzes that the media file has been played, and sending the adjusted play series numbers to the analyzing module.

11. A random play method applicable to a random play system for processing a playlist comprising a plurality of media files to be played so as for the random play system to determine play states of the media files, wherein the playlist at least comprises play items and play series numbers corresponding to the play items, the random play method comprising the steps of:
storing a number of the media files of the playlist;
marking the play states of the media files of the playlist and storing marked information in a flag register;
selecting one of the media files while performing a play task; analyzing a play state of the selected media file according to the marked information stored in the flag register; and
playing the selected media file when an analyzing result indicates that the selected media file has not been played yet.

12. The random play method of claim 1 1, wherein the flag register comprises a plurality of bits respectively corresponding to the media files of the playlist and marking current play states of the media files of the playlist.

13. The random play method of claim 12, wherein that a value of the bits is equal to a predefined first value indicates that one of the media files corresponding to the bits has not been played yet, and that the value is equal to a predefined second value indicates that another one of the media files corresponding to the bits has already been played.

14. The random play method of claim 1 1, further comprising setting a data type for the flag register according to the number of the media files of the playlist.

15. The random play method of claim 14, wherein the data type is one selected from a group consisting of a short integer, an integer and a long integer.

16. The random play method of claim 1 1, further comprising the steps of:
generating a random number; and
converting the random number into a play series number of the playlist according to a predefined operation mechanism.

17. The random play method of claim 16, wherein the random number is generated by referring to a current time.

18. The random play method of claim 16, wherein the generated random number is limited within the play series numbers of the playlist based on a modulo operation.

19. The random play method of claim 11, further comprising the steps of:
marking a play state of one of the media files in the flag register when the media file is played;
having a counter to count a count number of the media files that have been played;
comparing the count number of the media files that have already been played and the number of the media files of the playlist;
setting each of the bits in the flag register to a first value when the count number is compared to be bigger than the number of the media files of the playlist; and clearing the counter.

20. The random play method of claim 11, further comprising adjusting the play series numbers according to a predefined operation mechanism when an analyzing result indicates that the media file has been played and analyzing a play state of the selected media file according to the marked information stored in the flag register.
